(19) United States
(12) Patent Application Publication
(10) Pub. No.: US 2012/0215880 A1
(43) Pub. Date: Aug. 23, 2012

(54) FORWARDING DATA FROM SERVER TO DEVICE

(76) Inventor: VIKAS LAMBA, BANGALORE (IN)

(21) Appl. No.: 13/032,644

(22) Filed: Feb. 23, 2011

(51) Int. Cl. G06F 15/16

(52) U.S. Cl. 709/217

(57) ABSTRACT

Various embodiments of systems and methods for forwarding data from a continuation server to handheld devices are disclosed. At the continuation server, protocol connections established from the handheld devices is received. A stack is created on the continuation server, which stores a status of each protocol connection received. The status indicates an availability of the protocol connection between the corresponding handheld device and the continuation server. The connectivity between the continuation server and the handheld device is maintained. Once a data notification is received by the continuation server, the stack is invoked to retrieve the status of each protocol connection. The data notification may include an availability of data to be downloaded to the handheld devices. Based upon the availability of the protocol connections between the continuation server and the handheld devices, the data notification and the available data are forwarded from the continuation server to the corresponding handheld devices.

### FIELD

The field generally relates to computer systems, and more particularly to methods and systems for transferring data from a server to a device.

### BACKGROUND

Enterprise content management generally relates to managing content involving digital data of an enterprise or a business venture. Providing timely and accurate device access to enterprise applications and processes is a vital requirement for end users. Synchronizing the device with the enterprise content is essential to bring the device in line with the latest state of technology and content provided by the enterprise. Currently, a pull based technology is utilized to synchronize the device data with the enterprise content, wherein the device triggers a data download from the enterprise. This type of synchronization may not always yield data download for every synchronizing action because the device is not aware when or whether any new data is available for download on the enterprise. Moreover, this type of synchronization does not provide timely data to the device, which may be critical for business applications that run on the device. Thus, techniques for more effective synchronization of devices with the enterprise are desirable.

### SUMMARY

Various embodiments of systems and methods for forwarding data from a continuation server to handheld devices are disclosed. In an embodiment, protocol connections established from the handheld devices is received at the continuation server. A stack is created on the continuation server, which stores a status of each protocol connection received. The status indicates an availability of the protocol connection between the corresponding handheld device and the continuation server. The stack holds the status of the protocol connection of each corresponding handheld device until the connection is suspended or until a data notification is received. The data notification may include an availability of data to be downloaded to the handheld devices. The stack maintains the connectivity between the continuation server and the handheld devices. Maintaining the connectivity includes continually monitoring the protocol connections of the handheld devices and re-establishing the suspended protocol connections between the continuation server and the handheld device. The stack is updated with the statuses of the protocol connections. Once a data notification is received by the continuation server, the stack is invoked to retrieve the status of each protocol connection. Based upon the availability of the protocol connections between the continuation server and the handheld devices, the data notification and the available data are forwarded from the continuation server to the corresponding handheld devices. If the protocol connection between a handheld device and the continuation server is suspended, the continuation server may send a suspension alert to the corresponding handheld device to re-establish the suspended protocol connection between the handheld device and the continuation server. The status of the protocol connection in the stack gets updated based upon the re-established protocol connection.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an overview of a system for forwarding data from a continuation server to handheld devices, according to an embodiment.

FIG. 2 is a block diagram illustrating an overview of a system for forwarding data from a continuation server to handheld devices, according to another embodiment.

FIG. 3 is a block diagram illustrating a stack utilized for forwarding data from a continuation server to handheld devices, according to an embodiment.

FIG. 4 is a process flow diagram illustrating a method for forwarding data from a continuation server to handheld devices, according to an embodiment.

FIG. 5A is a functional flow diagram illustrating a method for forwarding data from a continuation server to handheld devices, according to an embodiment.

FIG. 5B is a functional flow diagram illustrating a method for forwarding data from a continuation server to handheld devices, according to an embodiment.

FIG. 6 is a sequence diagram illustrating a data flow for forwarding data from a continuation server to handheld devices, according to an embodiment.

FIG. 7 is a sequence diagram illustrating a data flow for forwarding data from a continuation server to handheld devices, according to an embodiment.

FIG. 8 is a block diagram illustrating a computer system for forwarding data from a continuation server to handheld devices, according to an embodiment.

FIG. 9 is a block diagram illustrating an exemplary computer system, according to an embodiment.

### DETAILED DESCRIPTION

Embodiments of techniques for systems and methods for forwarding data from a continuation server to handheld devices are disclosed. A continuation server may be described as a computing device responsible for executing computer applications across distributed networks. The continuation server may be installed on a network-interface zone that acts as an interface between devices existing in a public network and devices existing in a private network. A handheld device may be described as a portable computing device included in a public network. Some of the handheld devices may include a mobile phone, a personal digital assistant (PDA), a laptop, and the like. The handheld device in the public network may establish a connection with the continuation server in the network-interface zone to exchange data. Based upon a connection that is established between the continuation server and the handheld device, data synchronization may be invoked to intimate the handheld device about an availability of data, thus triggering a synchronization of handheld device only when there is an availability of data to be downloaded.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

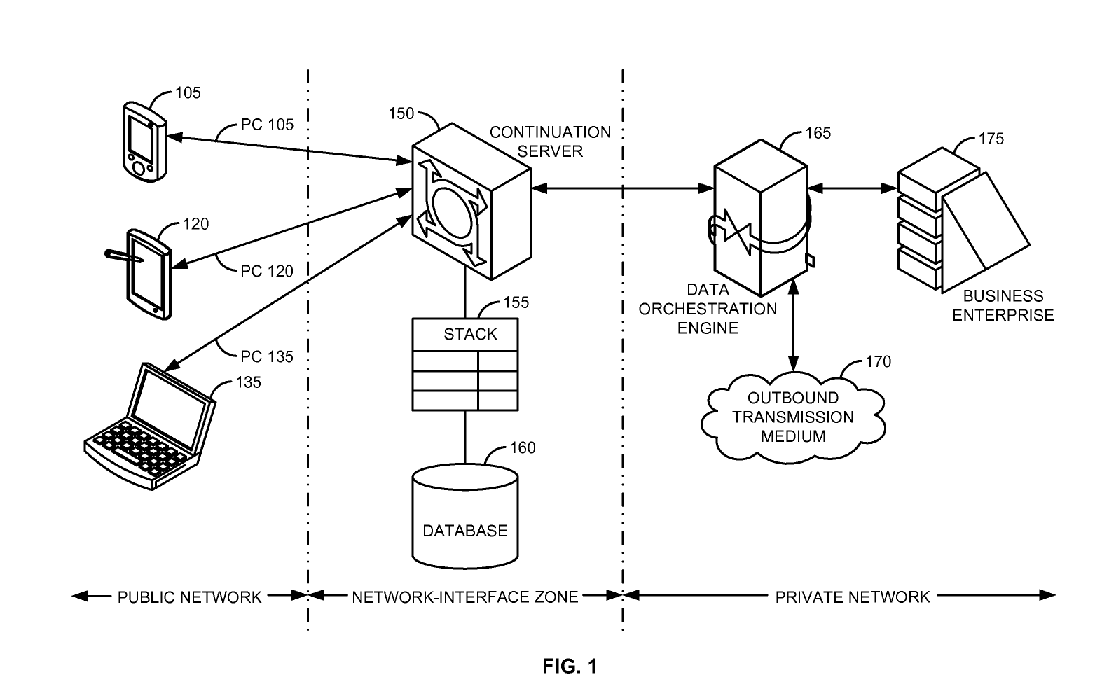

FIG. 1 is a block diagram illustrating an overview of a system for forwarding data from a continuation server to handheld devices, according to an embodiment. A continuation server may be described as a computing device installed on a network that manages data on the corresponding network. In an embodiment, a continuation server may be described as a computing device installed on a network-interface zone, which acts as an interface between devices existing in a public network and devices existing in a private network. In an embodiment, network-interface zone is independent of the public network and the private network. A handheld device may be described as a portable computing device included in a public network. A protocol connection may be described as a format of establishing a connection for communication between multiple computing devices, for instance, between a handheld device and a continuation server. Establishing a protocol connection may include establishing a communication between the computing devices, exchanging information between the computing devices, authenticating the established communication, detecting errors that may arise during communication, correcting the detected errors, and the like. The protocol connection is generally established to synchronize the multiple computing devices. Computing devices use protocol connections for exchanging information having an intended meaning, which will invoke an intended response. An example of a protocol connection may include a hypertext transfer protocol (HTTP) connection. One skilled in the relevant art will recognize different types of protocol connections to communicate between the computing devices. In an embodiment, a handheld device includes a polling agent and a data synchronization module. The polling agent is operable to send a protocol connection request from the handheld device to continuation server. The polling agent runs as a background service on the handheld device, and establishes a protocol connection with continuation server. If, at any instance, the protocol connection between the handheld device and continuation server is lost, the polling agent is invoked to re-establish the protocol connection. Thus, the polling agent is operable to establish the protocol connection between the handheld device and the continuation server, and to ensure that the protocol connection is not lost. A data synchronization module is responsible for synchronizing an associated handheld device with business enterprise. Business enterprise includes information, applications and processes that are extended to the associated handheld devices. Business enterprise may exist on a private network, and is extended to provide the required information to the handheld devices existing in the public network. The data synchronization module is triggered when there is data available to be downloaded to the handheld device, and the data synchronization module downloads the available data from business enterprise to the handheld device.

With reference to FIG. 1, handheld devices include a mobile phone 105, a personal digital assistant (PDA) 120, and a laptop computer 135. One skilled in the relevant art will recognize many such handheld devices that may receive a forwarded data from continuation server 150. Each of the handheld devices 105, 120 and 135 establish a corresponding protocol connection (PC 105, PC 120 and PC 135) with continuation server 150. Establishing a protocol connection may include initializing a polling agent present in each handheld device to send a protocol connection request to continuation server 150. In an embodiment, continuation server 150 accepts the received protocol connection request from the handheld devices to establish the protocol connection. For the received protocol connection, continuation server 150 creates stack 155 to store a status of each protocol connection. The status of the protocol connection indicates an availability of the protocol connection (PC 105, PC 120 and PC 135) between the handheld devices (105, 120 and 135) and continuation server 150. Stack 155 may be described as a data container that stores data in an assigned manner for further usage. In an embodiment, stack 155 is stored in database 160. Stack 155 stores the statuses of all the protocol connections (PC 105, PC 120 and PC 135) between the corresponding handheld devices (105, 120 and 135) and continuation server 150 until continuation server 150 receives a data notification or until the protocol connection is suspended. A data notification may include an availability of data to be downloaded on to the handheld devices (105, 120 and 135). Based upon the protocol connections (PC 105, PC 120 and PC 135) established between the handheld devices (105, 120 and 135) and continuation server 150, data synchronization may be invoked to intimate the handheld devices (105, 120 and 135) about the availability of data. Thus the data synchronization of the handheld devices (105, 120 and 135) is triggered only when there is an availability of data to be downloaded. Also, since stack 155 stores the statuses of all the protocol connections (PC 105, PC 120 and PC 135), a determination can be made of the available protocol connections to trigger the data synchronization for the handheld devices that have an available protocol connection. Continuation server 150 monitors the protocol connections (PC 105, PC 120 and PC 135) continually and updates the status of the protocol connections (PC 105, PC 120 and PC 135) in stack 155. Stack 155 includes a list of device identifiers (device ID) and a status of the protocol connections that are established between the handheld devices (105, 120 and 135) and continuation server 150. In an embodiment, stack 155 maintains the connectivity between continuation server 150 and the handheld devices (105, 120 and 135). Maintaining the connectivity includes continually monitoring the protocol connections of the handheld devices and re-establishing the suspended protocol connections between the continuation server 150 and the handheld devices (105, 120 and 135). Stack 155 is updated with the statuses of the protocol connections (PC 105, PC 120 and PC 135).

In response to the data notification received, continuation server 150 sends a data alert to the polling agent of the handheld device based upon the availability of the protocol connection between the handheld device and continuation server 150. The availability of the protocol connection is determined by invoking stack 155 to retrieve the status of each protocol connection. In response to the data alert, the polling agent of the handheld device invokes the data synchronization module associated with the handheld device for downloading the data to the handheld device.

In an embodiment, if the protocol connection between continuation server 150 and a handheld device is suspended, continuation server 150 notifies the polling agent associated with the corresponding handheld device about the suspended protocol connection. Continuation server 150 may send a suspension alert to the polling agent of the handheld device with the suspended protocol connection. Based upon the suspension alert received, the polling agent is instructed to send a protocol connection request from the corresponding handheld device to the continuation server to re-establish the suspended protocol connection.

In an embodiment, data orchestration engine 165 is in communication with business enterprise 175, and is installed in the private network. Data orchestration engine 165 may be defined as a computing device that allows the exchange of data between business enterprise 175 and handheld devices (105, 120 and 135). Data orchestration engine 165 identifies data, data notifications or any modification of data available for the handheld devices (105, 120 and 135) on business enterprise 175, and sends the data or data notifications from business enterprise 175 to continuation server 150. Continuation server 150 further forwards the data notification and the available data to the corresponding handheld devices (105, 120 and 135).

In an embodiment, outbound transmission medium 170 may be associated with data orchestration engine 165. Outbound transmission medium 170 accepts a registration of each handheld device to receive data or data notifications from business enterprise 175. Outbound transmission medium 170 sends such data notifications along with the corresponding data alert to the handheld devices (105, 120 and 135) that are registered with outbound transmission medium 170.

An example of a method for forwarding data from a continuation server to the handheld devices is disclosed herein. MOBILE DEVICE 105, PDA 120 and LAPTOP 135 exist in a public network. Business enterprise 175 includes information relating to a MOBILE DEVICE 105, a PDA 120 and a LAPTOP 135. MOBILE DEVICE 105, PDA 120 and LAPTOP 135 are registered with outbound transmission medium 170 to receive any data notifications available on business enterprise 175. The associated polling agents of MOBILE DEVICE 105, PDA 120 and LAPTOP 135 send a protocol connection request to continuation server 150 to establish the respective protocol connection (PC 105, PC 120 and PC 135). Continuation server 150 creates stack 155 to store the status of the availability of the protocol connections (PC 105, PC 120 and PC 135). Continuation server 150 continually monitors the protocol connections (PC 105, PC 120 and PC 135) and updates the status of the protocol connections in stack 155. In an embodiment, continuation server 150 stores stack 155 in database 160.

To include certain advanced features on MOBILE DEVICE 105, PDA 120 and LAPTOP 135, a new SOFTWARE UPDATE is available in business enterprise 175. Data orchestration engine 165 identifies the SOFTWARE UPDATE available for MOBILE DEVICE 105, PDA 120 and LAPTOP 135, and sends a data notification and the available data to continuation server 150. Based upon the data notification received by continuation server 150, continuation server 150 invokes stack 155 to retrieve the status of each protocol connection (PC 105, PC 120 and PC 135). At this instance, the statuses of the protocol connections (PC 105, PC 120 and PC 135) are CONNECTED. Continuation server 150 sends a data alert to the polling agent of MOBILE DEVICE 105, PDA 120 and LAPTOP 135 to notify the availability of the SOFTWARE UPDATE.

In response to the data alert, the polling agent of MOBILE DEVICE 105, PDA 120 and LAPTOP 135 invokes their associated data synchronization modules for downloading the SOFTWARE UPDATE to MOBILE DEVICE 105, PDA 120 and LAPTOP 135. The SOFTWARE UPDATE is forwarded from continuation server 150 to MOBILE DEVICE 105, PDA 120 and LAPTOP 135.

If protocol connection PC 135 is suspended, stack 155 is updated by continuation server 150. Continuation server 150 sends a suspension alert to the polling agent of LAPTOP 135 with the suspended protocol connection PC 135. Based upon the suspension alert, the polling agent of LAPTOP 135 is instructed to send a protocol connection request from LAPTOP 135 to continuation server 150, to re-establish the corresponding suspended protocol connection PC 135.

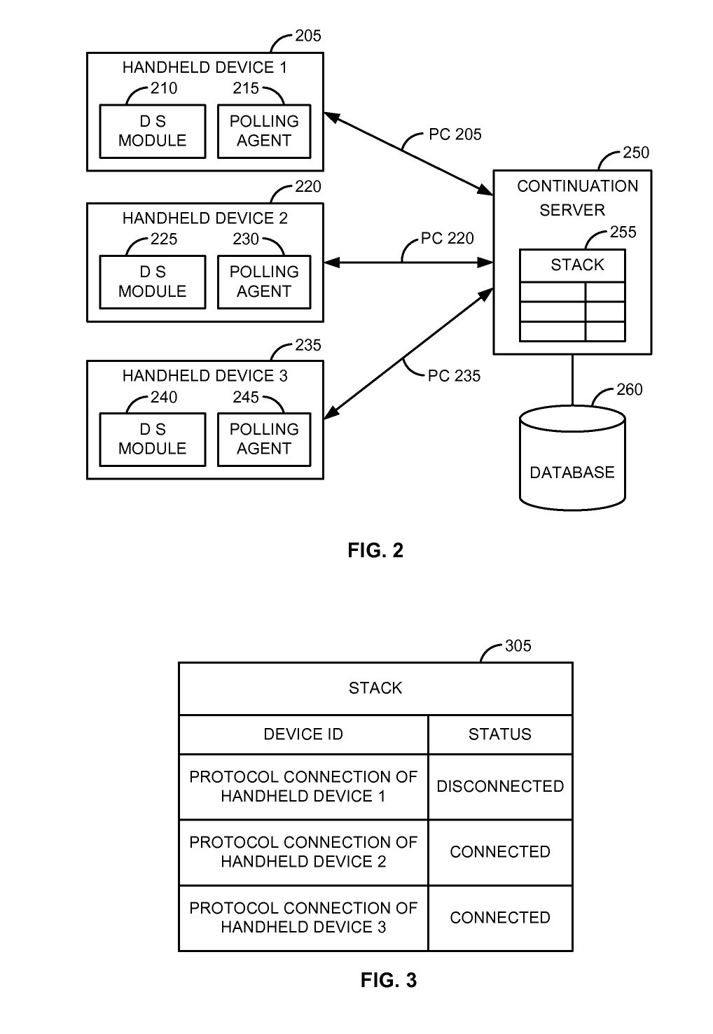

FIG. 2 is a block diagram illustrating an overview of a system for forwarding data from a continuation server to handheld devices, according to another embodiment. The handheld devices (for e.g., 205, 220 and 235) include associated data synchronization (DS) modules (for e.g., 210, 225 and 240) and polling agents (for e.g., 215, 230 and 245). Continuation server 250 receives protocol connections (for e.g., PC 205, PC 220 and PC 235) from corresponding handheld devices (205, 220 and 235). For the received protocol connections (PC 205, PC 220 and PC 235), continuation server 250 creates stack 255 to store a status of each protocol connection. The status indicates an availability of the protocol connections between the corresponding handheld devices and continuation server 250. The polling agents (215, 230 and 245) send a protocol connection request from the corresponding handheld device (205, 220 and 235) to continuation server 250 to establish the protocol connection (PC 205, PC 220 and PC 235) for the handheld devices (205, 220 and 235). Stack 255 holds the protocol connection (PC 205, PC 220 and PC 235) along with the corresponding statuses until a data notification is received by continuation server 250 or until the protocol connection (PC 205, PC 220 and PC 235) between continuation server 250 and the corresponding handheld device (205, 220 and 235) is suspended.

Based upon a data notification received, stack 255 is invoked to retrieve the statuses of each protocol connection (PC 205, PC 220 and PC 235). The data notification may include an availability of data to be downloaded to the handheld device (205, 220 and 235). Continuation server 250 sends a data alert to the polling agent (215, 230 and 245) of each handheld device (205, 220 and 235) based upon the availability of the corresponding protocol connection (PC 205, PC 220 and PC 235), for notifying the availability of data. In response to the data alert, the polling agent (215, 230 and 245) of each handheld device (205, 220 and 235) invokes a data synchronization module (210, 225 and 240) for downloading the data to the corresponding handheld device (205, 220 and 235). Based upon the statuses of the protocol connections (PC 205, PC 220 and PC 235), the data notification and the available data are forwarded from continuation server 250 to the corresponding handheld devices (205, 220 and 235).

In an embodiment, stack 255 holds the protocol connection (PC 205, PC 220 and PC 235) along with the corresponding statuses until the protocol connections (PC 205, PC 220 and PC 235) between the corresponding handheld devices (205, 220 and 235) and continuation server 250 are suspended. Stack 255 maintains the connectivity between continuation server 250 and handheld devices (205, 220 and 235). If a protocol connection (PC 205, PC 220 and PC 235) is suspended, continuation server 250 sends a suspension alert to the polling agent (215, 230 and 245) of the handheld device (205, 220 and 235) with a suspended protocol connection (PC 205, PC 220 and PC 235). Based upon the suspension alert, the polling agent (215, 230 and 245) is instructed to send a protocol request from the corresponding handheld device (205, 220 and 235) to continuation server 250 to re-establish the corresponding suspended protocol connection (PC 205, PC 220 and PC 235).

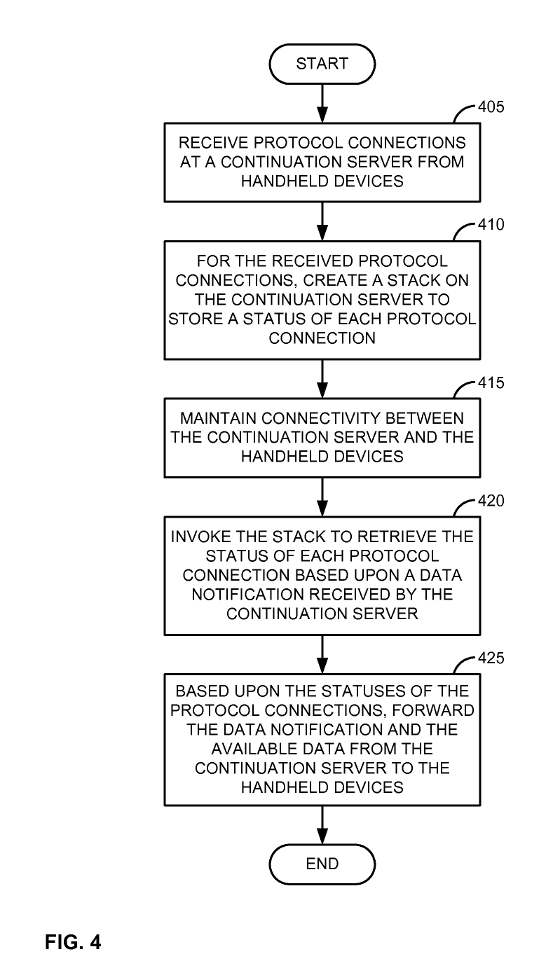

FIG. 3 is a block diagram illustrating a stack 305 utilized while forwarding data from a continuation server to handheld devices, according to an embodiment. The continuation server receives protocol connections from the corresponding handheld devices. For the received protocol connections, stack 305 is created on the continuation server to store a status of each of the protocol connections. A stack may be described as data container that stores data in an assigned manner such that the data stored can be used efficiently. In an embodiment, stack 305 stores the data that indicates a status of each protocol connection between a corresponding handheld device and the continuation server. The statuses of the protocol connections indicate the availability of the protocol connections between the continuation server and the handheld devices. The statuses of the protocol connections may include a ‘CONNECTED’ status and a ‘DISCONNECTED’ status to represent the protocol connections that are connected and the protocol connections that are disconnected. A protocol connection that is connected indicates that a connection (for e.g., protocol connection) is established between the handheld device and the continuation server. A protocol connection that is disconnected indicates that the connection between the handheld device and the continuation server is suspended, or disconnected, or has not been established, or the like. The continuation server monitors the protocol connections continually and updates the status of the protocol connections in stack 305. In an embodiment, stack 305 maintains the connectivity between the continuation server and the handheld devices. Maintaining the connectivity includes continually monitoring the protocol connections of the handheld devices and re-establishing the suspended protocol connections between the continuation server and the handheld device. The stack 305 is updated with the statuses of the protocol connections.

As illustrated in FIG. 3, stack 305 includes a list of device identifiers (device ID) and a status of the protocol connections of the handheld devices that have established a protocol connection with the continuation server. The device ID indicates a protocol connection of a corresponding handheld device and the status indicates the status of the protocol connection between the continuation server and the corresponding handheld device. For instance, stack 305 includes the device ID ‘PROTOCOL CONNECTION OF HANDHELD DEVICE 1’ and the corresponding status ‘DISCONNECTED’ as a first entry. The status of the ‘PROTOCOL CONNECTION OF HANDHELD DEVICE 1’ may be a current status of the connection as updated by the continuation server which continually monitors the protocol connections.

In an embodiment, all the handheld devices need not establish corresponding protocol connection with the continuation server at a same time. There may be some handheld devices that have not yet established corresponding protocol connections with the continuation server. There may be some handheld devices that have established corresponding protocol connections at different intervals of time. The continuation server updates stack 305 whenever a protocol connection is established between the continuation server and the corresponding handheld device. For instance, HANDHELD DEVICE 1 establishes a protocol connection with the continuation server at 11:00 hours. HANDHELD DEVICE 2 establishes a protocol connection with the continuation server at 13:30 hours. HANDHELD DEVICE 3 establishes a protocol connection with the continuation server at 14:00 hours. Since the continuation server continually monitors the protocol connections existing between the continuation server and the handheld devices, the continuation server updates the status of HANDHELD DEVICE 1 as connected at 11:00 hours, the status of HANDHELD DEVICE 2 at 13:30 hours, and the status of HANDHELD DEVICE 3 at 14:00 hours. Meanwhile, if the protocol connection of HANDHELD DEVICE 1 is suspended at 14:00 hours, the continuation server updates the status of the HANDHELD DEVICE 1 as DISCONNECTED. At 14:00 hours, stack 305 appears as shown in FIG. 3. Thus, stack 305 holds the protocol connections of all the handheld devices along with the corresponding statuses until the protocol connection is suspended or until a data notification is received by the continuation server.

According to an embodiment, stack 305 is invoked at two instances while forwarding data from the continuation server to the handheld devices, once when the continuation server monitors the protocol connection and updates the corresponding status in stack 305, and once again when the status of the protocol connection is retrieved based upon a data notification received by the continuation server. In an embodiment, for a first protocol connection that is established between a handheld device and the continuation server, stack 305 is created on the continuation server to store the status of the protocol connection that is established between the handheld device and the continuation server.

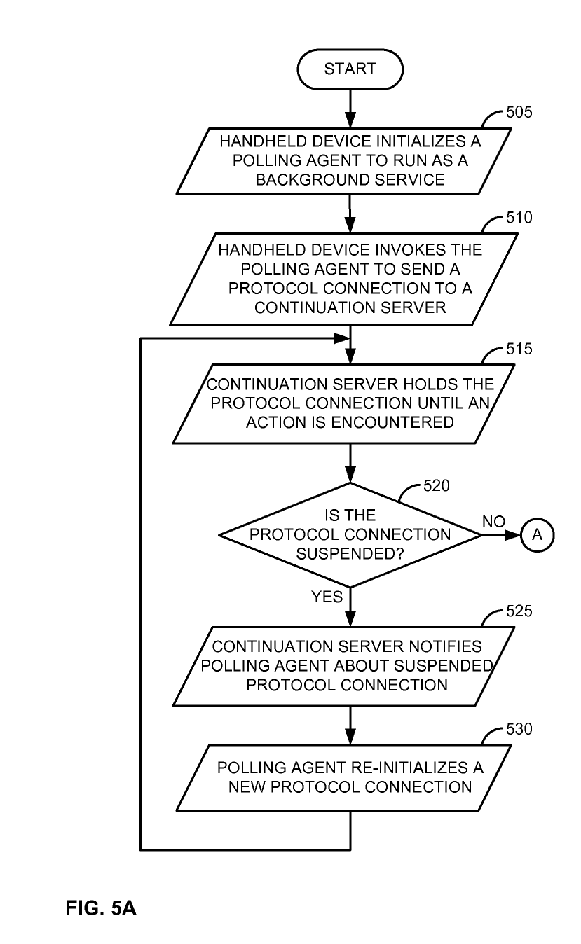

FIG. 4 is a process flow diagram illustrating a method for forwarding data from a continuation server to handheld devices, according to an embodiment. In process block 405, protocol connections from corresponding handheld devices are received at the continuation server. A polling agent present in each handheld device may be initialized to send a protocol connection request from the corresponding handheld device to the continuation server, to establish the protocol connection between the corresponding handheld device and the continuation server. In process block 410, for the received protocol connections, a stack is created on the continuation server to store a status of each protocol connection. The status of the protocol connection indicates an availability of the protocol connection between the corresponding handheld device and the continuation server. The stack holds the protocol connection and the corresponding status of each handheld device until the protocol connection is suspended or until a data notification is received by the continuation server. For instance, a protocol connection of a handheld device connected to the continuation server may have a ‘CONNECTED’ status stored in the stack, and if a protocol connection of a handheld device with the continuation server is suspended, the status stored in the stack may be updated to ‘DISCONNECTED’.

In process block 415, connectivity between the continuation server and the handheld devices is maintained. In an embodiment, maintaining the connectivity includes continually monitoring the protocol connections between the continuation server and the handheld device, and updating the stack. Maintaining also includes re-establishing the suspended protocol connection where the protocol connection between the handheld device and the continuation server is suspended. In process block 420, based upon a data notification received by the continuation server, the stack is invoked to retrieve the status of each protocol connection. A data notification includes an availability of data to be downloaded to the handheld devices. The continuation server may send a data alert to the polling agent of each handheld device based upon the availability of the corresponding protocol connection, for notifying the availability of data. In response to the data alert, the polling agent of each handheld device invokes a data synchronization module for downloading the data to the corresponding handheld device. In process block 425, based upon the statuses of the protocol connections, the data notification and the available data are forwarded from the continuation server to the handheld devices.

In an embodiment, the protocol connection between the corresponding handheld device and the continuation server may be suspended. The status of such a protocol connection residing in stack may be updated to ‘DISCONNECTED’, indicating the suspension of the connection. During such suspension, the continuation server may send a suspension alert to the polling agent of a handheld device with a suspended protocol connection. Based upon the suspension alert, the polling agent is instructed to send a protocol connection request from the corresponding handheld device to the continuation server, to re-establish the corresponding suspended protocol connection. Based upon the re-established protocol connection, the continuation server may update the corresponding status in the stack.

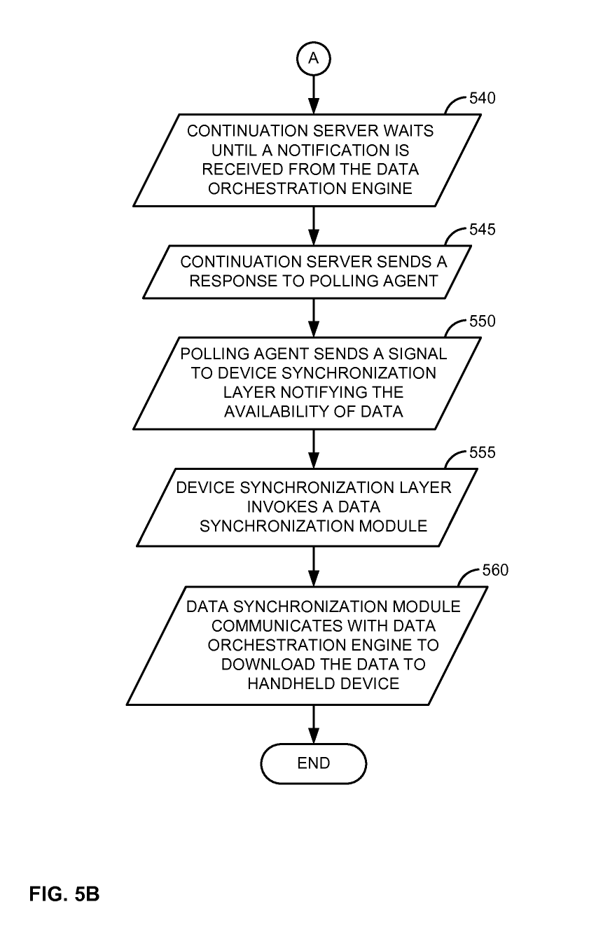

FIG. 5 is a functional flow diagram illustrating a method for forwarding data from a continuation server to handheld devices, according to an embodiment. In functional block 505, a handheld device initializes a polling agent to run as a background service in the handheld device. In an embodiment, the polling agent is included in the handheld device. In functional block 510, handheld device invokes the polling agent to establish a protocol connection between the handheld device and the continuation server. In an embodiment, a device synchronization layer associated with the handheld device initializes the polling agent to run as a background service in the handheld device. The device synchronization layer invokes the polling agent to run as a background service in the handheld device.

To establish a protocol connection between the handheld device and the continuation server, the polling agent sends a protocol connection request to the continuation server. In functional block 515, the continuation server holds the protocol connection of the handheld device until an action is encountered. In an embodiment, the continuation server creates a stack to store a status of the protocol connection between the handheld device and the continuation server. The status of the protocol connection may include a ‘CONNECTED’ status and a ‘DISCONNECTED’ status to represent the status of the protocol connection. The continuation server monitors the protocol connection continually and updates the status of the connection in the stack. For instance, a protocol connection of a handheld device may be having a ‘CONNECTED’ status at the beginning and at an end of a time period, the connection may have suspended due to a time-out. Since the continuation server continually monitors the status of the connection, the continuation server is able to update the status of the connection to ‘DISCONNECTED’ in the stack.

In decision block 520, a determination is made about the type of action encountered, wherein the determination is if the protocol connection is suspended. The types of action may include a ‘protocol connection being suspended’ or a ‘data notification being received’. If the protocol connection between the handheld device and the continuation server is suspended, the functional flow proceeds to functional block 525. If the protocol connection is not suspended, the functional flow proceeds to reference connector ‘A’.

In functional block 525, the continuation server notifies the polling agent associated with the handheld device about the suspended protocol connection. In functional block 530, the polling agent re-initializes a new protocol connection between the corresponding handheld device and the continuation server. The functional flow proceeds to functional block 515, where the continuation server holds the connection until an action is encountered. In an embodiment, the stack maintains the connectivity between the continuation server and the handheld devices. Maintaining the connectivity includes continually monitoring the protocol connections of the handheld devices and re-establishing the suspended protocol connections between the continuation server and the handheld device. The stack is updated with the statuses of the protocol connections.

FIG. 5B is a functional flow diagram illustrating a method for forwarding data from a continuation server to handheld devices, according to an embodiment. Reference connector ‘A’ represents the steps carried out from functional block 505 to decision block 520. The functional flow when the protocol connection is not suspended begins from functional block 540. In functional block 540, the continuation server waits until a data notification is received from a data orchestration engine. The data notification may include an availability of data to be downloaded to the handheld device. Based upon the data notification received by the continuation server, in functional block 545, the continuation server sends a data alert to the polling agent to notify the availability of the data. In response to the data alert, in functional block 550, the polling agent sends a signal to a device synchronization layer notifying the availability of the data. In functional block 555, the device synchronization layer invokes a data synchronization module, which communicates with the data orchestration engine in functional block 560, to download the data to the handheld device.

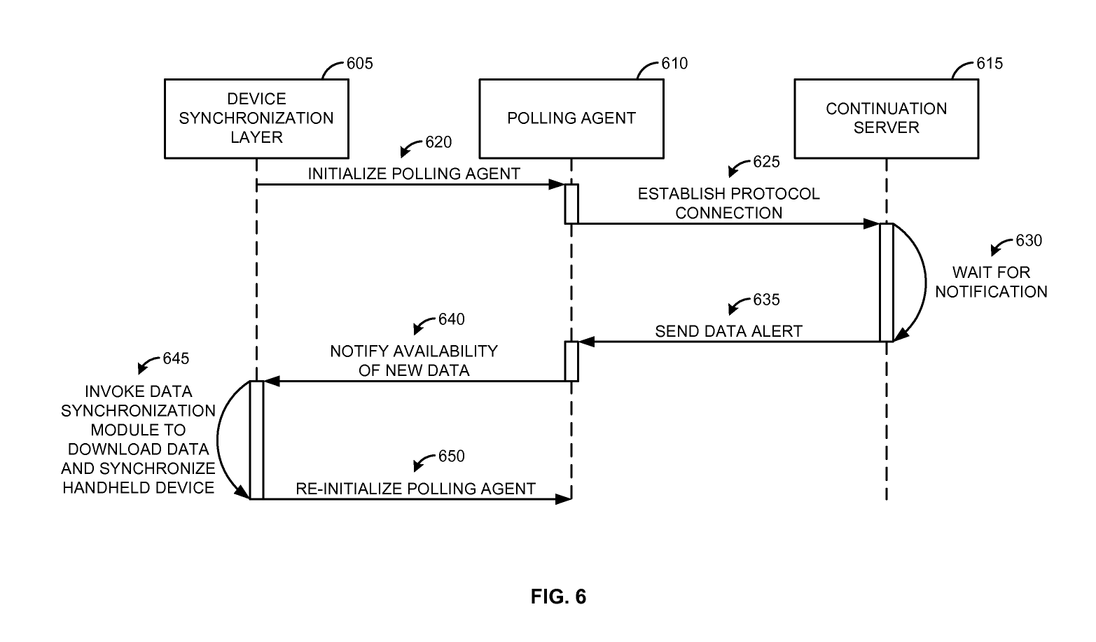

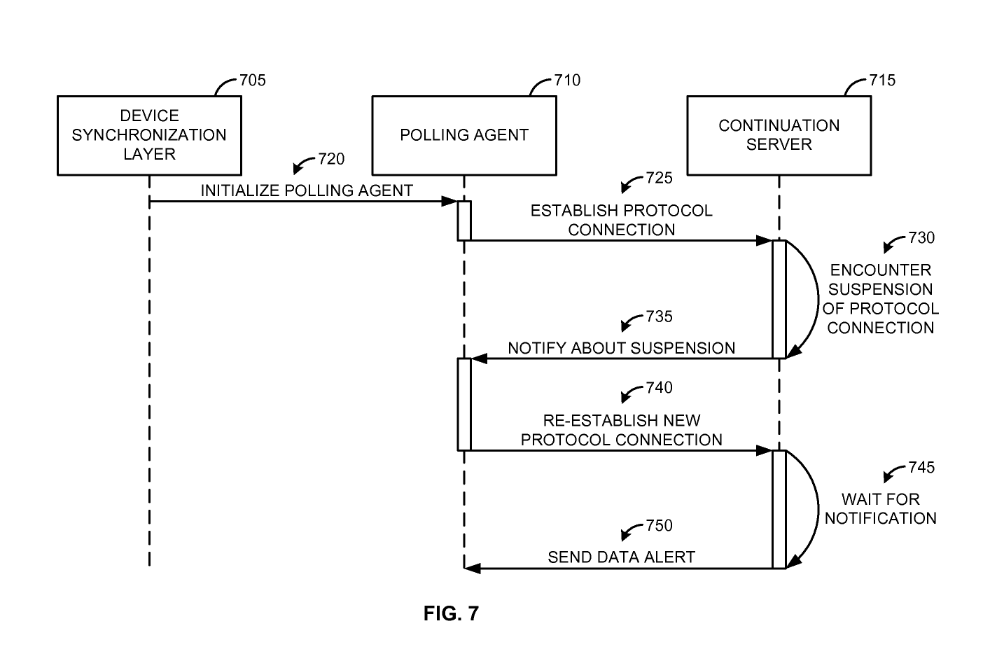

FIG. 6 and FIG. 7 are sequence diagrams illustrating a data flow for forwarding data from a continuation server to handheld devices, according to an embodiment. The sequence diagrams FIG. 6 and FIG. 7 represent all the interactions and the operations involved in the method for forwarding the data from the continuation server to the handheld devices. FIG. 6 and FIG. 7 illustrate process objects including device synchronization layer 605 and 705, polling agent 610 and 710 and continuation server 615 and 715, respectively, along with their respective vertical dotted lines originating from them. The vertical dotted lines of the device synchronization layer 605 and 705, polling agent 610 and 710 and continuation server 615 and 715, respectively, represent the processes that may exist simultaneously. The horizontal arrows (for e.g., 620, 625, and 635; and 720, 725, and 735) represent the data flow between the vertical dotted lines originating from their respective process objects (for e.g., 605, 610 and 615; and 705, 710, and 715). Activation boxes between the horizontal arrows represent the process that is being performed in the respective process object.

With reference to FIG. 6, device synchronization layer 605 initializes a polling agent 610 on each handheld device, to run as a background service. The activation box at the end of the horizontal arrow 620 represents this initialization of the polling agent 610. Polling agent 610 establishes a protocol connection 625 between polling agent 610 and continuation server 615. In an embodiment, the protocol connection is established by sending a protocol connection request from polling agent 610 to continuation server 615. Continuation server 615 holds the established protocol connection and waits for a data notification to be received 630.

The activation box at the end of the horizontal arrow 625 represents the instance when the continuation server holds the connection and waits for a data notification. The ‘hold-and-wait’ action of the continuation server may be referred to as maintaining the connectivity between the continuation server and the handheld devices. Maintaining the connectivity includes continually monitoring the protocol connections of the handheld devices and re-establishing the suspended protocol connections between the continuation server and the handheld device. The stack is updated with the statuses of the protocol connections. The data notification includes an availability of data to be downloaded to the handheld device. In an embodiment, continuation server 615 creates a stack to hold a status of the protocol connection, the status indicating an availability of the protocol connection between the handheld device and the continuation server. Continuation server 615 continually monitors the protocol connection and updates the status of the protocol connection in the stack. If the protocol connection is established, the stack may be updated with a ‘CONNECTED’ status, and if the protocol connection is suspended, the stack may be updated with a ‘DISCONNECTED’ status.

Once the data notification is received, continuation server 615 sends a data alert 635 to polling agent 610. The activation box at the end of the horizontal arrow 635 represents the receiving of the data alert by polling agent 610. Based upon the received data alert, polling agent 610 notifies the availability of the new data 640 to device synchronization layer 605. Based upon this data notification, device synchronization layer 605 invokes data synchronization module to download data and synchronize the handheld device 645. The activation box at the end of the horizontal arrow 640 represents this synchronization. Once the handheld device is synchronized, device synchronization layer 605 re-initializes the polling agent 650 to polling agent 610. The sequence continues from horizontal arrow 625 where the protocol connection is established between polling agent 610 and continuation server 615.

With reference to FIG. 7, the horizontal arrows 720 and 725 are as explained in FIG. 6, at horizontal arrows 620 and 625. The sequential data flow when the protocol connection suspends begins from the arrow 730 at continuation server 715. The activation box at the end of the horizontal arrow 725 represents an instance when continuation server 715 encounters a suspension of the protocol connection 730 between polling agent 710 and continuation server 715. Continuation server 715 notifies polling agent 710 about the suspension of the protocol connection 735. The activation box at the end of the horizontal arrow 735 represents an action carried out by polling agent 710 as a result of the suspension, where polling agent 710 is advised to take the corresponding actions. Polling agent 710 re-establishes the suspended protocol connection 740 with continuation server 715. Continuation server 715 holds the re-established protocol connection and waits for a data notification to be received 745. The activation box at the end of the horizontal arrow 740 represents the instance when the continuation server holds the connection and waits for a data notification. Once the data notification is received, continuation server 715 sends a data alert 750 to polling agent 710. The sequential data flow from when continuation server 715 sends the data alert 750 to polling agent 710 continues as explained in FIG. 6, at 635.

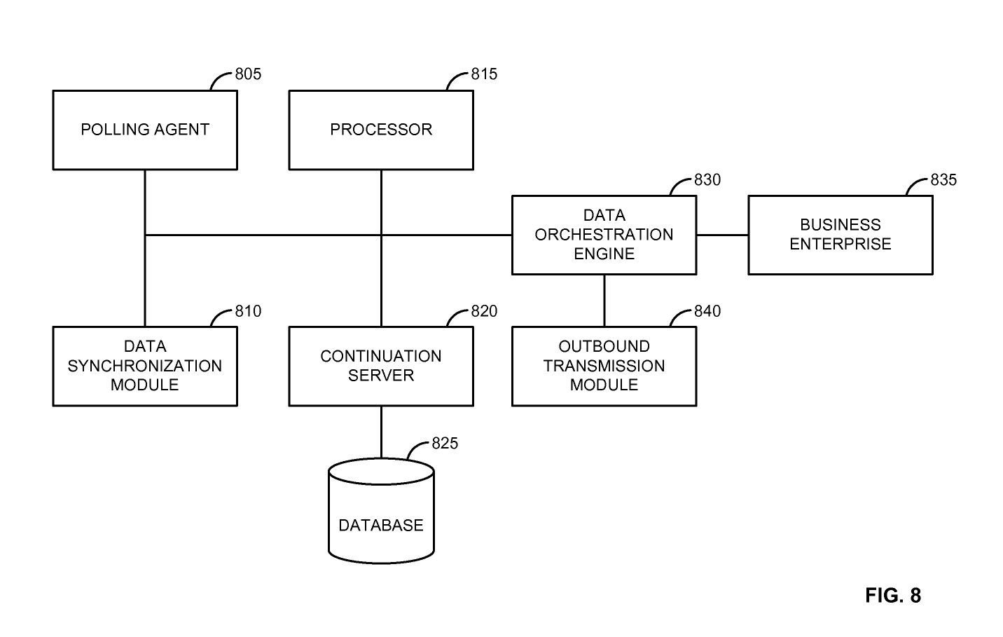

FIG. 8 is a block diagram illustrating a computer system for forwarding data from a continuation server to handheld devices, according to an embodiment. Computer system 800 includes polling agent 805, data synchronization module 810, processor 815, continuation server 820, database 825, data orchestration engine 830, and business enterprise 835. In an embodiment, polling agent 805 and data synchronization module 810 are in communication with processor 815 and continuation server 820. Continuation server 820 is in communication with database 825. Data orchestration engine 830 is in communication with processor 815 and continuation server 820, and business enterprise 835. In an embodiment, polling agent 805 and data synchronization module 810 are included in a handheld device. In another embodiment, outbound transmission module 840 is in communication with data orchestration engine 830.

In an embodiment, polling agent 805 is initialized to send a protocol connection request to continuation server 820 and establish a protocol connection with continuation server 820. In an embodiment, a handheld device includes an associated polling agent. Many such handheld devices establish corresponding protocol connections with continuation server 820 through their associated polling agents. In an embodiment, a device synchronization layer invokes polling agent 805 to run as a background service. Polling agent 805 is further invoked to send the protocol connection request to continuation server 820.

For the received protocol connections, processor 815 creates a stack on continuation server 820, to store a status of each protocol connection. The status of a protocol connection indicates an availability of the protocol connection between the corresponding handheld device and continuation server 820. Continuation server 820 continually monitors the status of each protocol connection through processor 815, and updates the stack with the current status of each protocol connection. For instance, a protocol connection of a handheld device ‘MOBILE PHONE’ connected to continuation server 820 may have a ‘CONNECTED’ status stored in the stack, and if a protocol connection of the ‘MOBILE PHONE’ with the continuation server is suspended, the status stored in the stack may be updated to ‘DISCONNECTED’. Thus, the stack includes a list of the protocol connections from the handheld devices along with their corresponding statuses. The statuses of the protocol connections are stored in the stack until continuation server 820 receives a data notification or until the protocol connections are suspended. Thus, continuation server 820 holds the protocol connections from the handheld devices and waits until it encounters an action, where the action may include receiving a data notification or suspension of the protocol connection. Processor 815 associated with stack maintains the connectivity between the continuation server 820 and the handheld devices. Maintaining the connectivity includes continually monitoring the protocol connections of the handheld devices and re-establishing the suspended protocol connections between the continuation server 820 and the handheld device. The stack is updated with the statuses of the protocol connections.

Based upon a data notification received by continuation server 820, the stack is invoked by processor 815 to retrieve the statuses of the protocol connections. A data notification may include an availability of data to be downloaded on the handheld devices. For instance, a ‘SOFTWARE UPDATE’ may be available for the ‘MOBILE PHONE’, and the data notification of such an availability of data is received by continuation server 820. In an embodiment, data orchestration engine 830 may send such data notifications to continuation server 820 about an availability of data. Data orchestration engine 830 may identify the data notification available for the handheld device on business enterprise 835, and sends the data notifications along with the available data from business enterprise 835 to continuation server 820. In an embodiment, the ‘SOFTWARE UPDATE’ available for the “MOBILE PHONE' is residing in business enterprise 835.

In response to receiving the data notification, continuation server 820 sends a data alert to polling agent 805 of each handheld device based upon the availability of the corresponding protocol connection, for notifying the availability of data. In response to receiving the data alert, polling agent 805 sends a signal to the device synchronization layer to notify the availability of data. The device synchronization layer invokes data synchronization module 810 to communicate with data orchestration engine 830, and download the data to the handheld device. Data orchestration engine 830 forwards the data notification and the available data to data synchronization module 810 through continuation server 820, based upon the status of the protocol connection between continuation server 820 and polling agent 805 of the handheld device. The ‘SOFTWARE UPDATE’ available for the ‘MOBILE DEVICE’ is sent from business enterprise 835 to data synchronization module 810 associated with the ‘MOBILE PHONE’ through continuation server 820, based upon the ‘CONNECTED’ status of the protocol connection between continuation server 820 and the ‘MOBILE DEVICE’.

In an embodiment, if the protocol connection between polling agent 805 and continuation server 820 is suspended, processor 815 associated with continuation server 820 sends a suspension alert to polling agent 805 of the associated handheld device. Polling agent 805 of the associated handheld device re-establishes the suspended protocol connection with continuation server 820. Polling agent 805 sends a protocol connection request to continuation server 820 to re-establish the suspended protocol connection. Processor 815 associated with continuation server 820 updates the stack with the current status of the protocol connection with polling agent 805 of the handheld device, and holds the protocol connection until a data notification is received or until the protocol connection is suspended again.

In an embodiment, the handheld devices along with the associated polling agents 805 and the data synchronization modules 810 are included in a public network, and data orchestration engine 830 and business enterprise 835 are included in a private network. To forward the data available on business enterprise 835 for the handheld devices, continuation server 820 is installed on a network-interface zone, which is independent of the public network and the private network. Data orchestration engine 830 identifies the data available on business enterprise 835 and notifies continuation server 820. Continuation server 820 invokes the stack to determine the statuses of each protocol connections between continuation server 820 and the corresponding handheld device. Based upon an availability of the protocol connection, continuation server 820 forwards the data notification and the available data to the corresponding handheld device.

In an embodiment, data orchestration engine 830 may have associated outbound transmission module 840. Outbound transmission module 840 accepts a registration of the handheld devices for receiving any data notifications available on business enterprise 835. When the data is available for the handheld devices, outbound transmission module 840 sends the data notification and the corresponding data alert to the handheld devices that are registered. Continuation server 820 includes the protocol connections from the corresponding handheld devices, enabling the forwarding of the data notification and the available data to the handheld devices and accessibility to data orchestration engine 830, enabling the receiving of the data notification.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

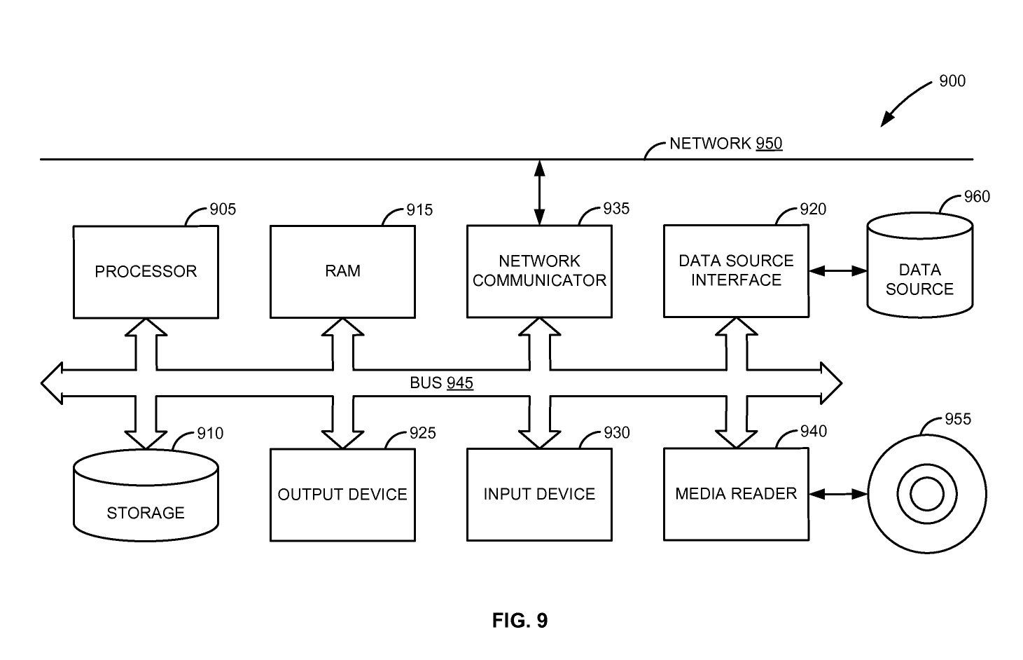

FIG. 9 is a block diagram of an exemplary computer system 900. The computer system 900 includes a processor 905 that executes software instructions or code stored on a computer readable storage medium 955 to perform the above-illustrated methods of the invention. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment of the invention, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, continuation servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for forwarding data from a continuation server to one or more handheld devices, comprising:
receiving at the continuation server, one or more protocol connections from the corresponding handheld devices;
for the received protocol connections, creating a stack on the continuation server to store a status of each protocol connection, the status indicating an availability of the protocol connections between the corresponding handheld devices and the continuation server;
maintaining connectivity between the continuation server and the handheld devices;
invoking the stack to retrieve the status of each protocol connection, based upon a data notification indicating an availability of data to be downloaded to the handheld devices, received at the continuation server; and
based upon the statuses of the protocol connections, forwarding the data notification and the available data from the continuation server to the corresponding handheld devices.

2. The computer implemented method of claim 1, wherein the protocol connection is received in response to:
initializing a polling agent on each handheld device, the polling agent configured to send a protocol connection request from the corresponding handheld device to the continuation server; and
establishing the corresponding protocol connection between the corresponding handheld device and the continuation server.

3. The computer implemented method of claim 1, wherein the stack holds the protocol connections along with the corresponding statuses until the data notification is received by the continuation server.

4. The computer implemented method of claim 1, wherein, in response to the data notification received, the continuation server sends a data alert to the polling agent of each handheld device based upon the availability of the corresponding protocol connection, for notifying the availability of data.

5. The computer implemented method of claim 4, wherein in response to the data alert, the polling agent of each handheld device invokes a data synchronization module for downloading the data to the corresponding handheld device.

6. The computer implemented method of claim 1, wherein the stack holds the protocol connections along with the corresponding statuses until the protocol connections between the corresponding handheld devices and continuation server are suspended.

7. The computer implemented method of claim 6, wherein the continuation server sends a suspension alert to the polling agent of a handheld device with a suspended protocol connection.

8. The computer implemented method of claim 7, wherein based upon the suspension alert, the polling agent is instructed to send a protocol connection request from the corresponding handheld device to the continuation server to re-establish the suspended protocol connection.

9. The computer implemented method of claim 1, wherein maintaining connectivity comprises:
continually monitoring the protocol connections of the handheld devices;
re-establishing the suspended protocol connections between the continuation server and the handheld devices; and
updating the stack with the statuses of the protocol connections.

10. The computer implemented method of claim 1, further comprises a data orchestration engine for:
identifying one or more data notifications available for the handheld devices on a business enterprise; and
sending the data notifications along with available data from the business enterprise to the continuation server.

11. The computer implemented method of claim 1, wherein the continuation server is installed on a network-interface zone, the network-interface zone being independent of the public network of the handheld devices and the private network of the data orchestration engine.

12. The computer implemented method of claim 1, wherein the continuation server comprises:
the protocol connections from corresponding handheld devices, enabling the forwarding of the data notification and the available data to the handheld devices; and
an accessibility to the data orchestration engine, enabling the receiving of data notification.

13. A computer system for forwarding data from a continuation server to one or more handheld devices, comprising:
a processor operable for reading and executing instructions stored in one or more memory elements; and
the one or more memory elements storing instructions for:
a polling agent to send one or more protocol connections from the handheld devices to the continuation server;
the processor to create a stack on the continuation server for storing a status of each protocol connection, indicating the availability of the protocol connections between the corresponding handheld devices and the continuation server;
the continuation server to maintain connectivity with the handheld devices and to invoke the stack and retrieve the status of each protocol connection, based upon a data notification received; and
a data synchronization module to receive the data notification and the available data forwarded from the continuation server to the handheld devices, based upon the statuses of the protocol connections.

14. The computer system of claim 13 further comprising:
a data orchestration engine to identify one or more data notifications available for the handheld devices on a business enterprise, and to send the data notifications from the business enterprise to the continuation server; and
an outbound transmission module in communication with the data orchestration engine to accept a registration of the handheld devices for receiving the data notifications, and to send the data notifications to the handheld devices that are registered with the outbound transmission medium.

15. The computer system of claim 13, wherein the handheld device comprises the polling agent and the data synchronization module.

16. The computer system of claim 13, wherein the continuation server stores the created stack on a database, and retrieves the stack from the database based upon the data notification received.

17. The computer system of claim 13, wherein a public network comprises the handheld devices and a private network comprises the data orchestration engine.

18. An article of manufacture including a computer readable storage medium to tangibly store instructions, which when executed by a computer, cause the computer to:
receive at a continuation server, one or more protocol connections from corresponding one or more handheld devices;
for the received protocol connections, create a stack on the continuation server to store a status of each protocol connection, the status indicating an availability of the protocol connections between the corresponding handheld devices and the continuation server;
maintain connectivity between the continuation server and the handheld devices;
invoke the stack to retrieve the status of each protocol connection, based upon a data notification indicating an availability of data to be downloaded to the handheld devices, received by the continuation server; and
based upon the statuses of the protocol connections, forward the data notification and the available data from the continuation server to the corresponding handheld devices.

19. The article of manufacture of claim 18, wherein the protocol connection is received in response to:
initializing a polling agent on each handheld device, the polling agent configured to send a protocol connection request from the corresponding handheld device to the continuation server; and
establishing the corresponding protocol connection between the corresponding handheld device and the continuation server.

20. The article of manufacture of claim 18, wherein maintaining connectivity comprises:
continually monitoring the protocol connections of the handheld devices;
re-establishing the suspended protocol connections between the continuation server and the handheld devices; and
updating the stack with the statuses of the protocol connections.
